(19) United States
(12) Patent Application Publication
(10) Pub. No.: US 2025/0232766 A1
(43) Pub. Date: Jul. 17, 2025

(54) NEXT-GEN AI INTERACTIVE VOICE RESPONSE SYSTEMS AND METHODS FOR ROADSIDE ASSISTANCE

(71) Applicant: Allstate Insurance Company, Northbrook, IL (US)

(72) Inventors: Kyle Walters, Northbrook, IL (US); Brandon Tarvin, Northbrook, IL (US); Todd Bucco, Northbrook, IL (US); Michael Coulter, Northbrook, IL (US)

(21) Appl. No.: 19/016,435

(22) Filed: Jan. 10, 2025

Related U.S. Application Data
(60) Provisional application No. 63/620,530, filed on Jan. 12, 2024.

(51) Int. Cl. G10L 15/183; G06F 9/451; G06F 40/103; G06Q 30/015; G10L 15/18; G10L 15/22

(52) U.S. Cl. CPC G10L 15/183; G06F 9/453; G06F 40/103; G06Q 30/015; G10L 15/1815; G10L 15/22

(57) ABSTRACT

An interaction voice response apparatus and method includes obtaining, from a chat bot, interaction data from an interaction with a user and based on a prompt, generating, with a large language model communicatively coupled to the chat bot and directed by the prompt, content based on the interaction data from the interaction with the user corresponding to data fields in a format defined by the prompt, wherein the content comprises direct extractions directly extracted from the interaction data, inferences deduced from the interaction data, or combinations thereof, generating, with the large language model, deduction flag indications, wherein a positive deduction flag indication of the deduction flag indications is generated when the content comprises an inference of the inferences, and outputting a data set comprising at least one next intent recommendation as a deduction based on the content and the indications in the format.

### CROSS-REFERENCE TO RELATED APPLICATIONS

The present application claims the benefit of U.S. Provisional Patent Application No. 63/620,530 filed on Jan. 12, 2024, the entirety of which is incorporated by reference herein.

### TECHNICAL FIELD

The present disclosure relates to techniques for improving communication between a human user and an automatic assistance system, such as roadside assistance that implements generative artificial intelligence (“AI”), configured to contextually infer information not readily available in a human provided input and note such inferences via one or more deduction flags to complete one or more queries defined by an engineered prompt.

### BACKGROUND

Interactive voice response (IVR) is an automated assistance system technology, such as a chat bot, that enables callers to receive or provide information, or make requests using voice or menu inputs, without speaking to a live agent. IVR systems can respond with pre-recorded or dynamically generated audio to further direct users on how to proceed. However, there are challenges with extracting content from audio inputs to accurately determine the needs of a caller.

Accordingly, there is a need to improve communication between a user, such as a human user as a caller, and the automatic assistance system.

### SUMMARY

According to the subject matter of the present disclosure, an interaction voice response (IVR) apparatus, includes: one or more memories; and one or more processors coupled to the one or more memories storing computer-executable instructions configured to cause the IVR apparatus, when executed by the one or more processors, to: obtain, from a chat bot, interaction data from an interaction with a user and based on a prompt; generate, with a large language model communicatively coupled to the chat bot and directed by the prompt, content based on the interaction data from the interaction with the user corresponding to one or more data fields in a format defined by the prompt, wherein the content comprises one or more direct extractions directly extracted from the interaction data, one or more inferences deduced from the interaction data, or combinations thereof; generate, with the large language model, one or more deduction flag indications, wherein a positive deduction flag indication of the one or more deduction flag indications is generated when the content comprises an inference of the one or more inferences; and output a data set comprising at least one next intent recommendation as a deduction based on the content and the one or more deduction flag indications in the format.

According to the subject matter of the present disclosure, a system for interaction voice response (IVR) includes a processor; and a memory storing computer-executable instructions that, when executed by the processor, cause the system to: obtain, from a chat bot, interaction data from an interaction with a user and based on a prompt; generate, with a large language model communicatively coupled to the chat bot and directed by the prompt, content based on the interaction data from the interaction with the user corresponding to one or more data fields in a format defined by the prompt, wherein the content comprises one or more direct extractions directly extracted from the interaction data, one or more inferences deduced from the interaction data, or combinations thereof; generate, with the large language model, one or more deduction flag indications, wherein a positive deduction flag indication of the one or more deduction flag indications is generated when the content comprises an inference of the one or more inferences; and output a data set comprising at least one next intent recommendation as a deduction based on the content and the one or more deduction flag indications in the format. The interaction data comprises a text file based on the interaction with the user. A negative deduction flag indication of the one or more deduction flag indications is generated when the content comprises a direct extraction of the one or more direct extractions.

According to the subject matter of the present disclosure, a method for interaction voice response (IVR) includes obtaining, from a chat bot, interaction data from an interaction with a user and based on a prompt; generating, with a large language model communicatively coupled to the chat bot and directed by the prompt, content based on the interaction data from the interaction with the user corresponding to one or more data fields in a format defined by the prompt, wherein the content comprises one or more direct extractions directly extracted from the interaction data, one or more inferences deduced from the interaction data, or combinations thereof; generating, with the large language model, one or more deduction flag indications, wherein a positive deduction flag indication of the one or more deduction flag indications is generated when the content comprises an inference of the one or more inferences; and outputting a data set comprising at least one next intent recommendation as a deduction based on the content and the one or more deduction flag indications in the format.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an illustrative block diagram of a system implementing a generative AI interactive voice response (IVR) process and including system components, accordingly to one or more embodiments as shown and described herein.

FIG. 2 schematically depicts an illustrative example text input and extracted data generated by the generative AI IVR process of FIG. 1.

FIG. 3 schematically depicts another illustrative example text input and extracted data generated by the generative AI IVR process of FIG. 1.

FIG. 4 schematically depicts another illustrative example text input and extracted data generated by the generative AI IVR process of FIG. 1.

FIG. 5 depicts an illustrative flowchart of an IVR implemented method utilizing one or more system components of FIG. 1, according to one or more embodiments shown and described herein

FIG. 6 schematically and structurally depicts a system with communicatively coupled system components for implementing an IVR process of FIGS. 1-4 and/or method of FIG. 5, according to one or more embodiments shown and described herein.

### DETAILED DESCRIPTION

Embodiments of the present disclosure relate to systems, methods, and computer implemented programs providing a large language model (LLM) and prompt engineering to interpret transcribed audio and produce details for input to an application program interface (API). Non-limiting examples of such details may include vehicle make, model, year, and color details for input to a roadside API.

For example, a roadside API may be a service or system configured to interact with a user such as a driver of a vehicle to identify the assistance the driver requires and deploy resources that are needed to help the driver. Features described herein are directed to providing improvements to an interactive voice response (IVR) experience with a user and help advance the interaction to meet the user's needs such as requesting resources to assist with a roadside issue. While aspects are described with reference to roadside assistance, it is understood that this is just an example implementation environment.

Embodiments described herein are directed to augmenting an API utilizing IVR such as a roadside API that a user interacts with to digitally, and optimally without a human agent's assistance, to report and issue and receive assistance for that issue such as a flat tire, no fuel, or other issue. For example, a roadside API may be initiated by a user through, for example, a phone call to a roadside assistance hotline, a mobile application, or the like. The roadside API, through an IVR experience, may through audio or through automatic text based communication interact with the user to collect information. In the case of an auditory interaction, the audio data is processed by a transcription API such as OpenAI's Audio API service Whisper, Google's AI Speech-to-Text API, or the like. The transcription API generates a transcription of the audio data, which is fed into a LLM with a custom prompt. The LLM is directed by the custom prompt to interpret the transcription and extract datasets of information provided by the user. The datasets to be extracted are defined by the custom prompt. The custom prompt also defines the type, format, and other specifications for the desired output of the LLM. In some embodiments, the desired output format is JSON, a text format that is language independent and can be ingested by other modules such as the IVR experience employed by the roadside API. The IVR experience, based on the extracted datasets of information, for example provided in JSON format, can utilize the information to advance the interaction with the user, clarify conflicts, and deploy resources the user requires for assistance with their issue.

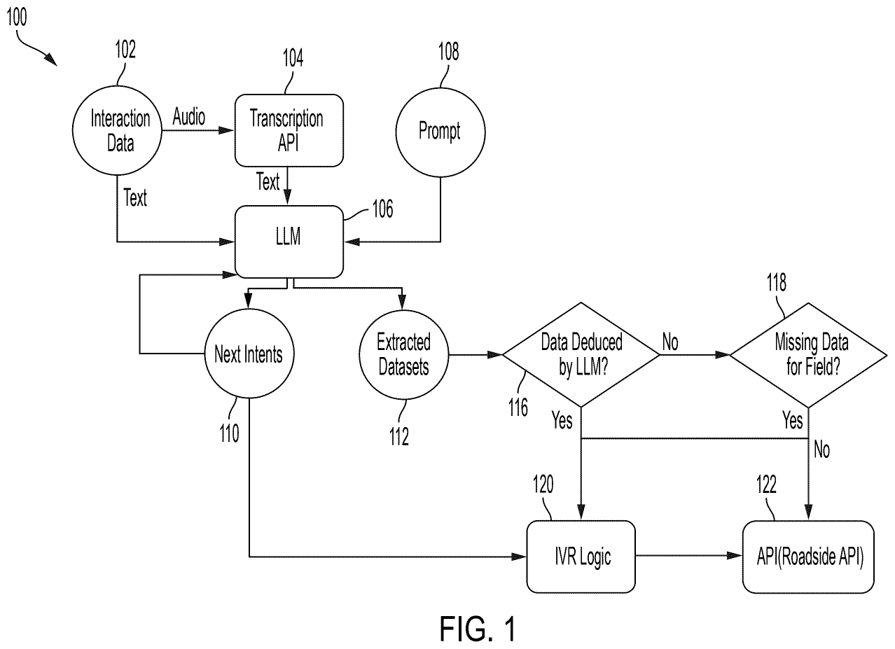

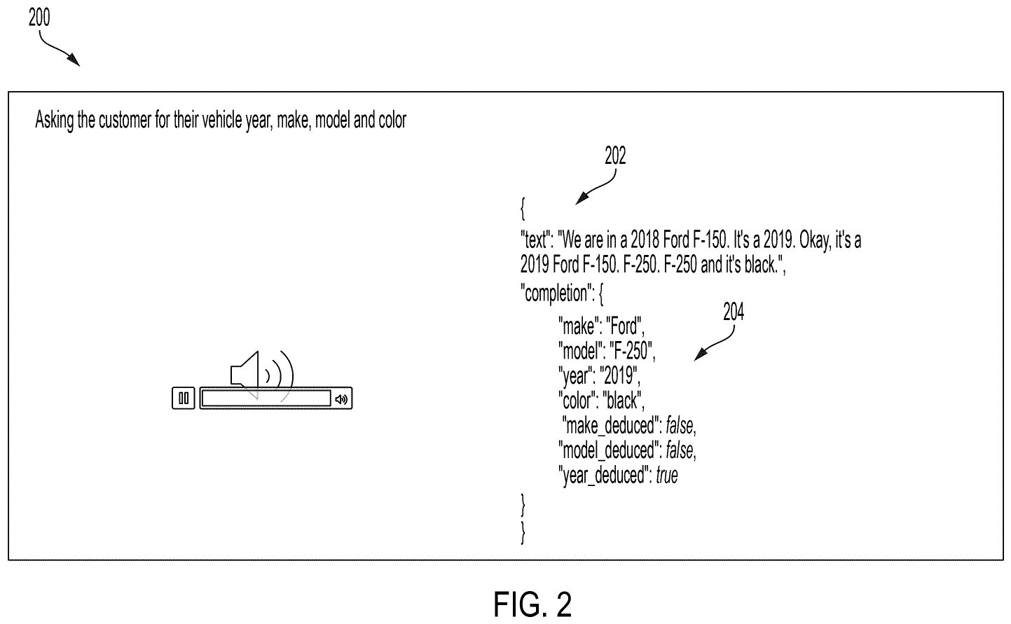

Aspects of the present disclosure will now be described with reference to FIG. 1 which depicts an illustrative system 100 including system components of an IVR apparatus to implement a generative AI IVR process. Additionally, reference will be made to FIGS. 2-4 that depict illustrative elements of the process. The system 100 includes an LLM 106 component, an IVR logic 120 component, and an API 122 component. The system 100 may include machine readable instructions stored in one or more memory components communicatively coupled to one or more processors 504 which instructions cause the system 100 to perform one or more control schemes, such as the generative AI interactive voice response process, described in greater detail further below, when executed by the one or more processors. Data stored and manipulated in the system 100 as described herein is utilized by a machine learning module, which is able to leverage a cloud computing-based network configuration such as the cloud to apply Machine Learning and Artificial Intelligence. This machine learning application may create models that can be applied by the system 100, to make it more efficient and intelligent in execution. As an example and not a limitation, the machine learning module may include artificial intelligence components selected from the group consisting of an artificial intelligence engine, Bayesian inference engine, and a decision-making engine, and may have an adaptive learning engine further comprising a deep neural network learning engine.

The system 100 begins to process implementation with interaction data 102 which may be collected from a chat bot verbally or textually communicating with a user for example through a service API such as a roadside API. For example, the user may have an issue with their vehicle for which they need assistance. To obtain assistance the user may load an application or call a phone number which connects them with a roadside API implementing an IVR experience. Thus, interaction data from an interaction with the user and based on a prompt may be obtained by the chat bot. The IVR experience engages with the user through a series of prompts and/or questions which as the conversation progresses are further refined to address the issue the user has with their vehicle. The conversation's progress may be defined by the information provided by the user which is processed by an artificial intelligence engine and/or rules-based logic to develop and deliver further prompts or questions from the IVR to the user. The orchestration of the further prompts or questions are made in response to determining the issue the user needs assistance with, the information needed to provide assistance, and the IVR's need to address conflicting information or request additional information to provide assistance with the goal of avoiding the need for a human agent to engage with the user.

The interaction data 102 may be in the form of audio or text generated from a text messaging service, chat field, email or the like. Audio data is fed through a transcription API 104 to generate a text based transcription of the audio data. The transcription API may be OpenAI's Audio API service Whisper, Google's AI Speech-to-Text API, or the like. The interaction data 102 may include a text file (including input text 202 of FIG. 2, described further below) based on the interaction with the user. The text file may be generated based off an audio file recorded based on the interaction with the user and may be processed from audio to text in a JavaScript Object Notation (JSON) format as the form and based on the transcription API.

The text, which may be generated directly by the user or as an output of the transcription API 104, is ingested by an LLM 106. LLMs are a type of artificial intelligence model that have been trained through deep learning algorithms to recognize, generate, translate, and/or summarize vast quantities of written human language and textual data. LLMs are a type of generative AI, which is a type of artificial intelligence that uses unstructured deep learning models to produce content based on user input. LLMs are considered a specific application of natural language processing that utilize advanced AI algorithms and technologies to generate believable human text an complete other text-based tasks. Examples of LLMs include OpenAI's ChatGPT, Nvidia's NeMO™ LLM, Meta's LLaMa, and Google's BERT.

The LLM 106 is directed to perform desired operations based on a prompt 108 that is provided to the LLM 106. The prompt 108 may be engineered to define what information the LLM should generate from the input, the form of the information that should be output, and any additional indications that the LLM should output such as comments or notes regarding the actions the LLM engage in to generate the outputs, which may not be data items. The prompt 108 may define data fields that the LLM 106 is directed to fill. For example, the prompt 108 may define data fields such as vehicle make, model, year; user's location, issue or service type, and others. The LLM 106 processes the input text and generates responses for as many of the data fields specified by the prompt 108 as possible and further formats the output in a form that the prompt 108 specifies. For example, the prompt 108 may indicate that the output should be formatted in a particular way that is ingestible by another API, such as in JSON.

FIG. 2 depicts an example of a prompt 108, 200 requesting the LLM 106 generate responses for the make, model, year, color data fields 204 based on the input text 202. In aspects, the one or more data fields 204 include at least one of a make of a vehicle, a model of the vehicle, or a year of the vehicle. As shown, the LLM 106 is able to discern from the input text 202 data values for each of the requested data fields 204. Moreover, the output is provided in JSON form.

The prompt 108 (FIG. 1) also includes a logic field that requests the LLM 106 to provide an indication as to whether a specific data field was deduced from the input text (e.g., set as “True,” deduced, in a corresponding deduction flag) or was directly indicated by the input text (e.g., set as “False,” not deduced, in a corresponding deduction flag).

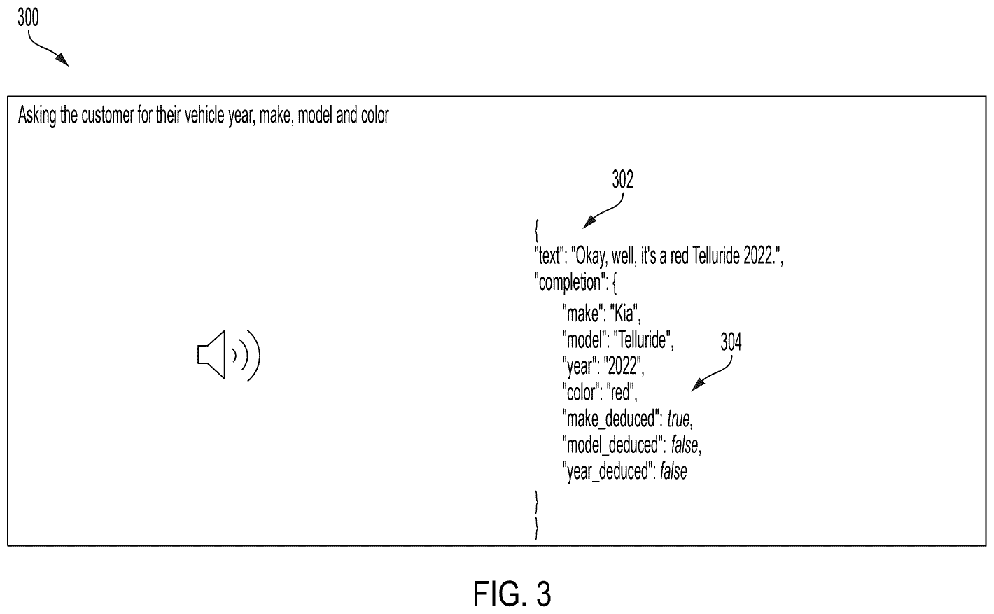

For example, as shown in a deduction interface 300 of FIG. 3, the make of the vehicle was not provided in the input text 302 of “Okay, well, it's a red Telluride 2022.” However, the LLM 106 is able to deduce that the make of the vehicle is a Kia based on the other information provided in the input text. Accordingly, in response to the prompt 108 requesting an indication as to whether the LLM deduced “make” data, the LLM 106 returns a value of “True” for the corresponding deduction flag in the make logic field 304 (set forth as “‘make_deduced’: true”).

In some embodiments, the prompt 108 of FIG. 1 may also include logic which determines a set of additional data fields that the LLM 106 is to be prompted to complete in response to the presently input text or a subsequent input text. The set of additional data fields are referred to herein as next intents 110.

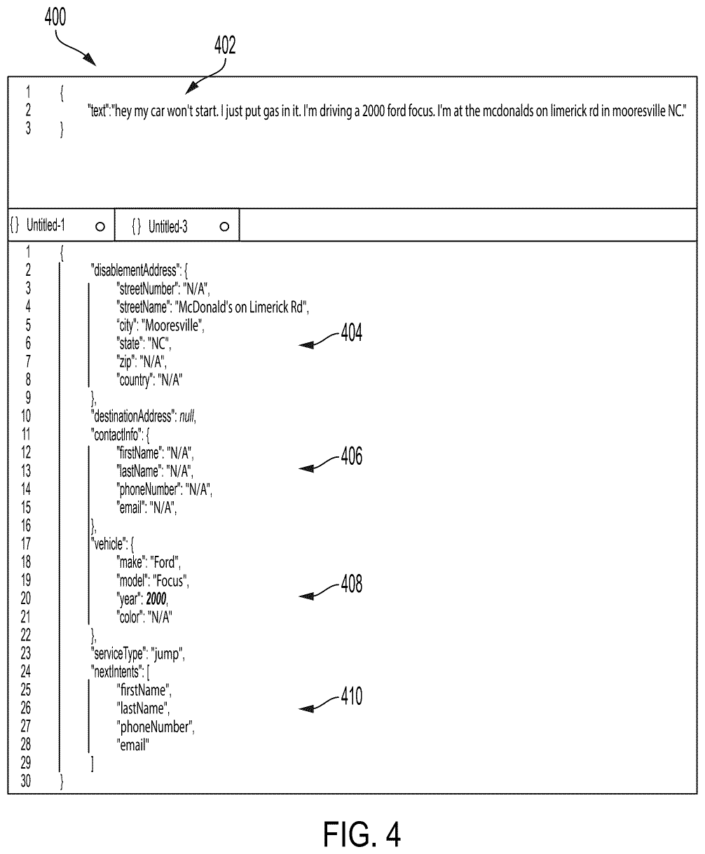

For example, FIG. 4 depicts an illustrative interface 400 including a text input 402, data fields 404, 406, and 408, and next intents 110, 410 that the LLM 106 processes and generates responses for based on the text input 402. In some embodiments, some of the data fields do not require the LLM 106 to provide a response for while others do. In an aspect, the at least one next intent recommendation (e.g., next intents 110) may correspond to an action comprising a service type. The next intents 110, 410 are defined, in the example provided here, based on the service type “jump” that is determined by the LLM 106. For difference types of service, one or more additional fields of information may be needed to help assist the user with their issue. In this example, the LLM 106 determined that the service type indicated by the user is a “jump” or a battery jump, which may have been deduced from the indications the user made that the car won't start and there is gas in the vehicle. In embodiments, a corresponding deduction flag indicative of inference by the LLM 106 may be associated with next intents 110.

Referring back to FIG. 1, the next intents 110 (e.g., next intents 410 depicted in FIG. 4) may be fed to the LLM 106 and/or to the IVR logic. The LLM 106, in response to the next intents 110, may reprocess the presently input text or a subsequent input text to generate data for the field specified by the next intents 110.

Content such as an extracted dataset 112 may be generated via LLM 106 communicatively coupled to the chat bot based on the interaction data 102 from the interaction with the user corresponding to one or more data fields 204 in a format (such as JSON) defined by the prompt. The content of the extracted dataset 112 may include one or more direct extractions directly extracted from the interaction data, one or more inferences deduced from the interaction data, or combinations thereof. A data set may be output including at least one next intent recommendation (e.g., of next intents 110) as a deduction based on the content of extracted dataset 112 and the one or more deduction flag indications in a format defined by the prompt 108. In an aspect, the data set may be formatted in JavaScript Object Notation (JSON) as the format.

The LLM 106 may generate the extracted dataset 112 based on the input text and the prompt 108. The extracted dataset 112 may be checked by one or more processes to determine whether additional follow ups or conflicts need to be resolved before proceeding with providing to the API 122 such as the roadside API for further action such as deploying resources to assist with the user's issue. The prompt may define a confidence interval that directs the LLM 106 to generate the content that meets or exceeds the confidence interval. As a non-limiting example, the extracted dataset 112 may be generated and output by the LLM 106 only when a p-value (e.g., a confidence interval) is achieved. That is, the LLM 106 may be prevented from returning a data value for a data field defined by the prompt when the p-value is less than a predefined threshold. However, the p-value may be set to a low value and the output may be subsequently validated in response to determining that the data value generated by the LLM 106 was deduced. This provides a means for allowing the LLM 106 to operate more freely with the generation of data while providing a secondary check on the validity of the data that is generated when it is deduced as opposed to directly extracted from a text input as indicated by the deduction flag and related process described herein.

With the LLM 106, one or more deduction flag indications may be generated, and a positive deduction flag indication of the one or more deduction flag indications is generated when the content of extracted dataset 112 includes an inference of the one or more inferences. A negative deduction flag indication of the one or more deduction flag indications is generated when the content of extracted dataset 112 includes a direct extraction of the one or more direct extractions. The positive deduction flag indication may corresponds a true value such as “True,” “1,” or “Yes”, and the negative deduction flag indication may correspond to a false value such as “False,” “0,” or “No.”

As a non-limiting embodiment, at block 116, the extracted dataset 112 is processed to determine whether any of the data fields were deduced by the LLM 106 and to set corresponding deduction flags. If a data field was deduced by the LLM 106 (“Yes” at block 116), the process proceeds to IVR logic 120. If no data fields were deduced by the LLM 106 (“No” at block 116), the process may proceed to send the extracted data 112 to the API 122 or the extracted data 112 may be further processed at block 118.

At block 118, the extracted dataset 112 is processed to determine whether any of the data fields are missing a data value. If a data field is missing a data value (“Yes” at block 118), the process proceeds to IVR logic 120. If no data fields that are required are missing a data value (“No” at block 118), the process may proceed to send the extracted data 112 to the API 122.

In an aspect, the data set including the at least one next intent recommendation (e.g., of next intents 110) as the deduction may be transmitted to an IVR logic module (e.g., IVR logic 120) configured to apply one or more rules to cause the IVR apparatus (e.g., of system 100) to generate additional information based on an instruction to query the user for additional information, a request for clarification from the user, a notice of a status of the action to a service provider, or combinations thereof. Based on the additional information, an instruction may be transmitted to an API to deploy a resource to implement the action. The API may be a roadside API, the resource may be a dispatch vehicle, and the action may be a service type, such as one of a jump, tow, or repair as described in examples herein.

As a non-limiting example, at the IVR logic 120 component, the process may implement one or more IVR logic rules. The IVR logic rules may include one or more business rules that will cause the IVR to behave in a predefined manner such as query the user for more information, request a clarification regarding a topic or conflicting information provide, provide a dispatch notice that a resource is being provided to assist the user with their issue, or the like. At API 122 may deploy the logic operation that the IVR logic 120 determines and/or proceed with a predefined engagement process with the user based on the extracted dataset 112 received from the LLM 106.

Embodiments described herein may be thus implemented by a computing architecture that is configured to implement generative AI such as a LLM 106 that receives as an input a transcript of a communication (i.e., a JSON transcript converted from a recorded audio with a human during an interaction) and an engineered prompt including one or more deduction flags. As described herein, the transcript of the communication may be generated by a natural language processing (NLP) model that coverts audio data into text-based data. The engineered prompt defines a set of instructions for the generative AI with respect to processing the text-based data of the transcript of the communication. For example, the prompt defines categories of information that is desired to be extracted and/or inferred by the generative AI from the text-based data of the transcript of the communication. A corresponding deduction flag within the prompt can indicate whether information has been extracted (i.e., via a “False” label) or interfered (i.e., via a “True” label) from the transcript. Additionally, the prompt may define the format of the output desired from the generative AI, such as outputting content in JSON format or other computer-readable format.

Thus, the generative AI outputs content that satisfies each of the fields defined by the prompt. In addition to the content, as set forth above, a deduction flag may be set for one or more of the fields to indicate whether the generative AI made an inference as to the information pertaining to the field when an associated confidence of the information from the received transcript is below a threshold and thus may not be reliably validated by either the text-based data of the transcript of the communication or other learned information including stored data that the generative AI relies upon to operate. Further inferences may be made regarding the outputs such as what type of service request is to be issued based on the analyzed input, such as whether a “tow” is required or a “repair” for a roadside assistance input.

In an example, a human may request roadside assistance stating in an audio that “I am stopped at a gas station near a ramp to enter Interstate 71N in my 2010 Murano and have two flat tires.” From this information, the generative AI system may extract the car is a model of Murano made in 2010 (with associated “false” deduction flags for the model and year outputs), infer it is a Nissan as a make of the car (with an associated “true” deduction flag), and infer a location of the vehicle (such as by tracking GPS data and looking up which gas stations are near the inputted 71N ramp entrance). The generative AI system may further as a next intent 110 infer that the human requesting roadside assistance is in need of a “tow” rather than a “repair” (also with an associated “true” deduction flag). The generative AI system may then generate an output configured to a request for a tow vehicle to be sent to the inferred location of the vehicle rather than a repair service vehicle (which could have been sent for a repair to change to a spare tire if a single tire had been damaged rather than the two damaged tires noted). Since two tires have been note as damaged by the generative AI system, the generative AI system is configured to infer via the next intent 110 that a tow of the vehicle via a tow vehicle is required rather than a repair of a single tire via a repair service vehicle.

In some embodiments, the deduction flag information can be further utilized to audit the operation of the generative AI model so that API engineers can improve the quality and performance of the IVR experience and service API. In embodiments, the one or more deduction flags as described herein may be utilized in training and testing of the LLM 106 or other LLMs utilized, including but not limited to those tested using an A/B testing framework or other experiment frameworks, to determine whether LLM training is performing above an acceptable level. The one or more deduction flags may thus be used to track how well the LLM training is working.

### Example Operations

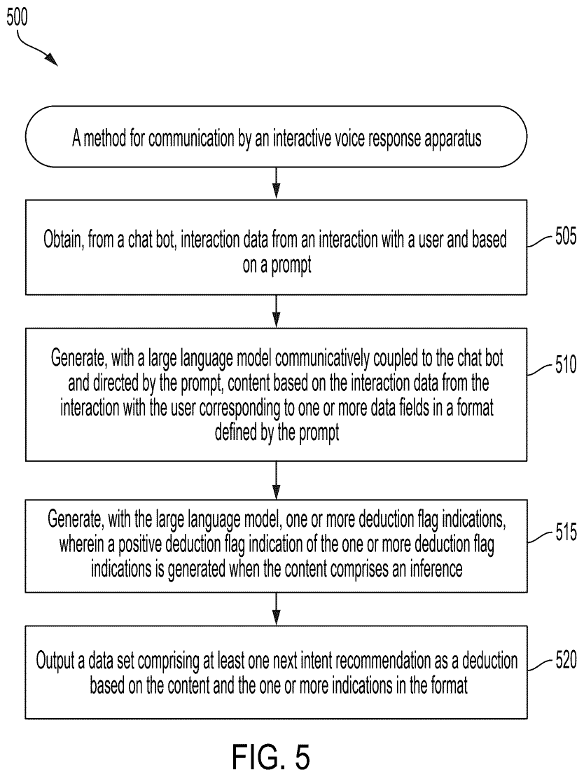

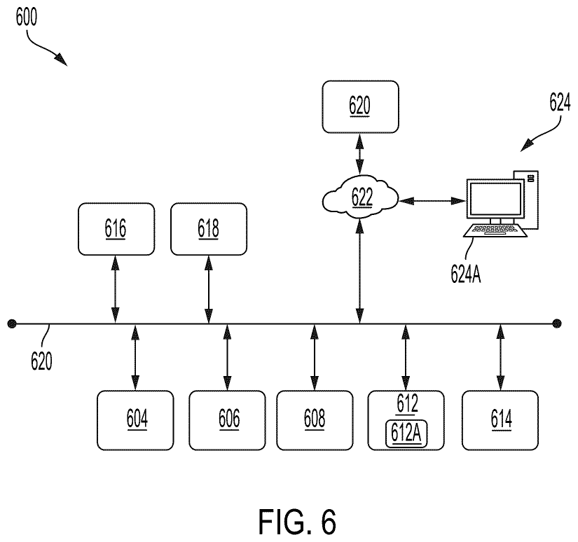

FIG. 5 shows an example method 500, optionally implemented by the IVR process and system 100 of FIG. 1 (and/or system 600 of FIG. 6 described in greater detail further below).

At block 505, interaction data from an interaction with a user and based on a prompt is obtained from a chat bot. For example, the interaction data may be interaction data 102 collected from a chat bot for processing by system 100, for example, as discussed with reference to FIGS. 1-4.

The interaction data may include a text file based on the interaction with the user. The text file may be generated based off an audio file recorded based on the interaction with the user and processed from audio to text in a JSON format as the form and based on a transcription API. In an aspect, the prompt may define a confidence interval. The confidence interval directs the large language model to generate the content that meets or exceeds the confidence interval.

At block 510, content may be generated, using a large language model communicatively coupled to the chat bot and directed by the prompt, based on the interaction data from the interaction with the user corresponding to one or more data fields in a format defined by the prompt. The content includes one or more direct extractions directly extracted from the interaction data, one or more inferences deduced from the interaction data, or combinations thereof. The content may correspond to extracted dataset 112 and block 116 as discussed with reference to FIG. 1. At block 510, the large language model may correspond to LLM 106 as discussed with reference to FIG. 1, the interaction data may correspond to interaction data 102 as discussed with reference to FIG. 1, and the prompt may correspond to prompt 108 as discussed with reference to FIGS. 1 and 2.

In certain aspects, the one or more data fields may include at least one of a make of a vehicle, a model of the vehicle, or a year of the vehicle, such as shown in data fields 204 of FIG. 2.

At block 515, using the large language model, one or more deduction flag indications are generated. A positive deduction flag indication of the one or more deduction flag indications is generated when the content comprises an inference of the one or more inferences. Block 515 may correspond to operations of the LLM 106 and/or blocks 116-118 as discussed with reference to FIG. 1.

In embodiments, a negative deduction flag indication of the one or more deduction flag indications is generated when the content comprises a direct extraction of the one or more direct extractions. The positive deduction flag indication may correspond a true value, and the negative deduction flag indication may correspond to a false value.

At block 520, a data set may be output comprising at least one next intent recommendation as a deduction based on the content and the one or more indications in the format. At block 520, the data set may correspond to the next intent 110 as discussed with reference to FIG. 1.

In an aspect, the data set may be formatted in JavaScript Object Notation (JSON) as the format. In embodiments, the at least one next intent recommendation of the data set comprises a respective positive deduction flag indication indicative of the deduction.

The at least one next intent recommendation may correspond to an action comprising a service type. The data set comprising the at least one next intent recommendation as the deduction may be transmitted to an IVR logic module configured to apply one or more rules to cause the IVR apparatus to generate additional information based on an instruction to query the user for additional information, a request for clarification from the user, a notice of a status of the action to a service provider, or combinations thereof. Based on the additional information, an instruction may be transmitted to an API to deploy a resource to implement the action comprising the service type. The API may be a roadside API, the service type may be one of a jump, a tow, or a repair, and/or the resource may be a dispatch vehicle.

In one aspect, method 500, or any aspect related to it, may be performed by an apparatus, such as system 100 of FIG. 1 or system 600 of FIG. 6, which includes various components operable, configured, or adapted to perform the method 500. System 600 is described below in further detail.

Note that FIG. 5 is just one example of a method, and other methods including fewer, additional, or alternative operations are possible consistent with this disclosure.

### Example System

Referring now to FIG. 6, an embodiment of a system 600 as described herein includes a communication path 602, one or more processors 604, a memory component 606 comprising one or more memories, an artificial intelligence module 612, a machine learning sub-module 612A of the artificial intelligence module 612, one or more databases 614, a chat bot module 616, a network interface hardware 618, a network 622, a server 620, a device 624, such as a computing device, and a user interface 624 for display on the device. The various components of the system 600 and the interaction thereof will be described in detail below. In embodiments herein, the system 600 comprises a memory as the memory component 606 storing computer-executable instructions that, when executed by a processor 604, cause the system to one or more logical processes as described herein, and/or methods are configured to implement one or more logical processes as described herein (such as method 500 of FIG. 5 and/or IVR process of FIG. 1 described herein).

While only one server 620 and one device 624 is illustrated in FIG. 6, the system 600 can comprise multiple servers containing one or more applications and/or computing devices. In some embodiments, the system 600 is implemented using a wide area network (WAN) or network 622, such as an intranet or the internet. The device 624 may include digital systems and other devices permitting connection to and navigation of the network 622. It is contemplated and within the scope of this disclosure that the device 624 may be a personal computer, a laptop device, a smart mobile device such as a smart phone or smart pad, or the like. Other system 600 variations allowing for communication between various geographically diverse components are possible. The lines depicted in FIG. 6 indicate communication rather than physical connections between the various components.

The system 600 comprises the communication path 602. The communication path 602 may be formed from any medium that is capable of transmitting a signal such as, for example, conductive wires, conductive traces, optical waveguides, or the like, or from a combination of mediums capable of transmitting signals. The communication path 602 communicatively couples the various components of the system 600. As used herein, the term “communicatively coupled” means that coupled components are capable of exchanging data signals with one another such as, for example, electrical signals via conductive medium, electromagnetic signals via air, optical signals via optical waveguides, and the like.

The system 600 of FIG. 6 also comprises the one or more processors 604. Each processor 604 can be any device capable of executing machine-readable instructions. Accordingly, each processor 604 may be a controller, an integrated circuit, a microchip, a computer, or any other computing device. Each processor 604 is communicatively coupled to the other components of the system 600 by the communication path 602. Accordingly, the communication path 602 may communicatively couple any number of processors 604 with one another, and allow the modules coupled to the communication path 602 to operate in a distributed computing environment. Specifically, each of the modules can operate as a node that may send and/or receive data.

The illustrated system 600 further comprises the memory component 606, which is coupled to the communication path 602 and communicatively coupled to a processor 604 of the one or more processors 604. The memory component 606 may be a non-transitory computer readable medium or non-transitory computer readable memory and may be configured as a nonvolatile computer readable medium. The memory component 606 may comprise RAM, ROM, flash memories, hard drives, or any device capable of storing machine-readable instructions such that the machine-readable instructions can be accessed and executed by the processor 604. The machine readable instructions may comprise logic or algorithm(s) written in any programming language such as, for example, machine language that may be directly executed by the processor 604, or assembly language, object-oriented programming (OOP), scripting languages, microcode, etc., that may be compiled or assembled into machine readable instructions and stored on the memory component 606. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

Still referring to FIG. 6, as noted above, the system 600 comprises a display, such as a graphical user interface (GUI) 624A, on a screen of the device 624 for providing visual output such as, for example, information, graphical reports, messages, or a combination thereof. The display on the screen of the device 624 is coupled to the communication path 602 and communicatively coupled to the processor 604. Accordingly, the communication path 102 communicatively couples the display to other modules of the system 600. The display can comprise any medium capable of transmitting an optical output such as, for example, a cathode ray tube, light emitting diodes, a liquid crystal display, a plasma display, or the like. Additionally, it is noted that the display or the device 624 can comprise at least one of the processor 604 and the memory component 606. While the system 600 is illustrated as a single, integrated system in FIG. 6, in other embodiments, the systems can be independent systems.

The system 600 comprises the artificial intelligence module 612 configured to implement a large language model such as LLM 106 as described herein. The machine-learning sub-module 612A of the artificial intelligence module 612 is configured to apply machine-learning models to the artificial intelligence models to implement the large language model and provide machine-learning capabilities to a neural network, as described in greater detail further below. The chat bot module 616 communicatively coupled to the artificial intelligence module 612 (and thus LLM 106) is configured to implement one or more process of a chat bot, such as to obtain interaction data from an interaction with a user and based on a prompt as described herein.

The artificial intelligence module 612, the machine-learning sub-module 612A, and the chat bot module 616 are coupled to the communication path 602 and communicatively coupled to the processor 604.

Data stored and manipulated in the system 600 as described herein is utilized by the artificial intelligence module 612, which is able to leverage a cloud computing-based network configuration such as the cloud to apply Machine Learning and Artificial Intelligence. This machine learning application may create models via the machine-learning sub-module 612A that can be applied by the system 600 (similar to the system 100), to make it more efficient and intelligent in execution. As an example and not a limitation, the artificial intelligence module 612 may include artificial intelligence components selected from the group consisting of an artificial intelligence engine, Bayesian inference engine, and a decision-making engine, and may have an adaptive learning engine further comprising a deep neural network learning engine.

The system 600 further includes the network interface hardware 618 for communicatively coupling the system 600 with a computer network such as network 622. The network interface hardware 618 is coupled to the communication path 602 such that the communication path 602 communicatively couples the network interface hardware 618 to other modules of the system 600. The network interface hardware 618 can be any device capable of transmitting and/or receiving data via a wireless network. Accordingly, the network interface hardware 618 can comprise a communication transceiver for sending and/or receiving data according to any wireless communication standard. For example, the network interface hardware 618 can comprise a chipset (e.g., antenna, processors, machine readable instructions, etc.) to communicate over wired and/or wireless computer networks such as, for example, wireless fidelity (Wi-Fi), WiMax, Bluetooth, IrDA, Wireless USB, Z-Wave, ZigBee, or the like.

Still referring to FIG. 6, data from various applications running on device 624 can be provided from the device 624 to the system 600 via the network interface hardware 618. The device 624 can be any device having hardware (e.g., chipsets, processors, memory, etc.) for communicatively coupling with the network interface hardware 618 and a network 622. Specifically, the device 624 can comprise an input device having an antenna for communicating over one or more of the wireless computer networks described above.

The network 622 can comprise any wired and/or wireless network such as, for example, wide area networks, metropolitan area networks, the internet, an intranet, satellite networks, or the like. Accordingly, the network 622 can be utilized as a wireless access point by the device 624 to access one or more servers (e.g., a server 620). The server 620 and any additional servers generally comprise processors, memory, and chipset for delivering resources via the network 622. Resources can include providing, for example, processing, storage, software, and information from the server 620 to the system 600 via the network 622. Additionally, it is noted that the server 620 and any additional servers can share resources with one another over the network 622 such as, for example, via the wired portion of the network, the wireless portion of the network, or combinations thereof. Where used herein, “a first element, a second element, or combinations thereof” reference an “and/or” combination similar to use herein of “at least one of a first element or a second element.”

### Example Clauses

Implementation examples are described in the following numbered clauses:

Clause 1: A interaction voice response (IVR) method, comprising: obtaining, from a chat bot, interaction data from an interaction with a user and based on a prompt; generating, with a large language model communicatively coupled to the chat bot and directed by the prompt, content based on the interaction data from the interaction with the user corresponding to one or more data fields in a format defined by the prompt, wherein the content comprises one or more direct extractions directly extracted from the interaction data, one or more inferences deduced from the interaction data, or combinations thereof; generating, with the large language model, one or more deduction flag indications, wherein a positive deduction flag indication of the one or more deduction flag indications is generated when the content comprises an inference of the one or more inferences; and outputting a data set comprising at least one next intent recommendation as a deduction based on the content and the one or more deduction flag indications in the format.

Clause 2: The method of Clause 1, wherein the interaction data comprises a text file based on the interaction with the user.

Clause 3: The method of Clause 2, wherein the text file is generated based off an audio file recorded based on the interaction with the user and is processed from audio to text in a JavaScript Object Notation (JSON) format as the form and based on a transcription application program interface (API).

Clause 4: The method of any one of Clauses 1-2, wherein a negative deduction flag indication of the one or more deduction flag indications is generated when the content comprises a direct extraction of the one or more direct extractions.

Clause 5: The method of Clause 4, wherein the positive deduction flag indication corresponds a true value, and the negative deduction flag indication corresponds to a false value.

Clause 6: The method of any one of Clauses 1-5, wherein the at least one next intent recommendation of the data set comprises a respective positive deduction flag indication indicative of the deduction.

Clause 7: The method of any one of Clauses 1-6, wherein the prompt defines a confidence interval, wherein the confidence interval directs the large language model to generate the content that meets or exceeds the confidence interval.

Clause 8: The method of any one of Clauses 1-7, wherein the data set is formatted in JavaScript Object Notation (JSON) as the format.

Clause 9: The method of any one of Clauses 1-8, wherein the one or more data fields comprise at least one of a make of a vehicle, a model of the vehicle, or a year of the vehicle.

Clause 10: The method of any one of Clauses 1-9, wherein the at least one next intent recommendation corresponds to an action comprising a service type.

Clause 11: The method of Clause 10, wherein the computer-executable instructions further cause the apparatus, when executed by the one or more processors, to: transmit the data set comprising the at least one next intent recommendation as the deduction to an IVR logic module configured to apply one or more rules to cause the IVR apparatus to generate additional information based on an instruction to query the user for additional information, a request for clarification from the user, a notice of a status of the action to a service provider, or combinations thereof.

Clause 12. The method of Clause 11, wherein the computer-executable instructions further cause the apparatus, when executed by the one or more processors, to: transmit based on the additional information an instruction to an application program interface (API) to deploy a resource to implement the action comprising the service type.

Clause 13: The method of Clause 12, wherein the application program interface is a roadside API, the service type comprises one of a jump, a tow, or a repair, and the resource comprising a dispatch vehicle.

Clause 14: One or more apparatuses, comprising: one or more memories comprising executable instructions; and one or more processors configured to execute the executable instructions and cause the one or more apparatuses to perform a method in accordance with any one or any combination of clauses 1-13.

Clause 15: One or more apparatuses configured for wireless communications, comprising: one or more memories; and one or more processors, coupled to the one or more memories, configured to cause the one or more apparatuses to perform a method in accordance with any one or any combination of Clauses 1-13.

Clause 16: One or more apparatuses configured for wireless communications, comprising: one or more memories; and one or more processors, coupled to the one or more memories, configured to perform a method in accordance with any one or any combination of Clauses 1-13.

Clause 17: One or more apparatuses, comprising means for performing a method in accordance with any one or any combination of Clauses 1-13.

Clause 18: One or more non-transitory computer-readable media comprising executable instructions that, when executed by one or more processors of one or more apparatuses, cause the one or more apparatuses to perform a method in accordance with any one or any combination of Clauses 1-13.

Clause 19: One or more computer program products embodied on one or more computer-readable storage media comprising code for performing a method in accordance with any one or any combination of Clauses 1-13.

Clause 20: One or more systems for IVR comprising a process and a memory storing computer-executable instructions that, when executed by the processor, cause the system to perform a method in accordance with any one or any combination of Clauses 1-13.

The terminology used herein is for the purpose of describing particular aspects only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An interaction voice response (IVR) apparatus, comprising: one or more memories; and one or more processors coupled to the one or more memories storing computer-executable instructions configured to cause the IVR apparatus, when executed by the one or more processors, to:
obtain, from a chat bot, interaction data from an interaction with a user and based on a prompt;
generate, with a large language model communicatively coupled to the chat bot and directed by the prompt, content based on the interaction data from the interaction with the user corresponding to one or more data fields in a format defined by the prompt, wherein the content comprises one or more direct extractions directly extracted from the interaction data, one or more inferences deduced from the interaction data, or combinations thereof;
generate, with the large language model, one or more deduction flag indications, wherein a positive deduction flag indication of the one or more deduction flag indications is generated when the content comprises an inference of the one or more inferences; and
output a data set comprising at least one next intent recommendation as a deduction based on the content and the one or more deduction flag indications in the format.

2. The IVR apparatus of claim 1, wherein the interaction data comprises a text file based on the interaction with the user.

3. The IVR apparatus of claim 2, wherein the text file is generated based off an audio file recorded based on the interaction with the user and is processed from audio to text in a JavaScript Object Notation (JSON) format and based on a transcription application program interface (API).

4. The IVR apparatus of claim 1, wherein a negative deduction flag indication of the one or more deduction flag indications is generated when the content comprises a direct extraction of the one or more direct extractions.

5. The IVR apparatus of claim 4, wherein the positive deduction flag indication corresponds a true value, and the negative deduction flag indication corresponds to a false value.

6. The IVR apparatus of claim 1, wherein the at least one next intent recommendation of the data set comprises a respective positive deduction flag indication indicative of the deduction.

7. The IVR apparatus of claim 1, wherein the prompt defines a confidence interval, wherein the confidence interval directs the large language model to generate the content that meets or exceeds the confidence interval.

8. The IVR apparatus of claim 1, wherein the data set is formatted in JavaScript Object Notation (JSON) as the format.

9. The IVR apparatus of claim 1, wherein the one or more data fields comprise at least one of a make of a vehicle, a model of the vehicle, or a year of the vehicle.

10. The IVR apparatus of claim 1, wherein the at least one next intent recommendation corresponds to an action comprising a service type.

11. The IVR apparatus of claim 10, wherein the computer-executable instructions further cause the IVR apparatus, when executed by the one or more processors, to: transmit the data set comprising the at least one next intent recommendation as the deduction to an IVR logic module configured to apply one or more rules to cause the IVR apparatus to generate additional information based on an instruction to query the user for the additional information, a request for clarification from the user, a notice of a status of the action to a service provider, or combinations thereof.

12. The IVR apparatus of claim 11, wherein the computer-executable instructions further cause the IVR apparatus, when executed by the one or more processors, to: transmit based on the additional information an instruction to an application program interface (API) to deploy a resource to implement the action comprising the service type.

13. The IVR apparatus of claim 12, wherein the API is a roadside API, the service type comprises one of a jump, a tow, or a repair, and the resource comprising a dispatch vehicle.

14. A system for interaction voice response (IVR), the system comprising:
a processor; and
a memory storing computer-executable instructions that, when executed by the processor, cause the system to:
obtain, from a chat bot, interaction data from an interaction with a user and based on a prompt;
generate, with a large language model communicatively coupled to the chat bot and directed by the prompt, content based on the interaction data from the interaction with the user corresponding to one or more data fields in a format defined by the prompt, wherein the content comprises one or more direct extractions directly extracted from the interaction data, one or more inferences deduced from the interaction data, or combinations thereof, wherein the interaction data comprises a text file based on the interaction with the user;
generate, with the large language model, one or more deduction flag indications, wherein a positive deduction flag indication of the one or more deduction flag indications is generated when the content comprises an inference of the one or more inferences, and wherein a negative deduction flag indication of the one or more deduction flag indications is generated when the content comprises a direct extraction of the one or more direct extractions; and
output a data set comprising at least one next intent recommendation as a deduction based on the content and the one or more deduction flag indications in the format.

15. The system of claim 14, wherein the text file is generated based off an audio file recorded based on the interaction with the user and is processed from audio to text in a JavaScript Object Notation (JSON) format and based on a transcription application program interface (API), the positive deduction flag indication corresponds a true value, and the negative deduction flag indication corresponds to a false value.

16. The system of claim 14, wherein the at least one next intent recommendation of the data set comprises a respective positive deduction flag indication indicative of the deduction.

17. The system of claim 14, wherein the prompt defines a confidence interval, wherein the confidence interval directs the large language model to generate the content that meets or exceeds the confidence interval.

18. A method for interaction voice response (IVR), the method comprising:
obtaining, from a chat bot, interaction data from an interaction with a user and based on a prompt;
generating, with a large language model communicatively coupled to the chat bot and directed by the prompt, content based on the interaction data from the interaction with the user corresponding to one or more data fields in a format defined by the prompt, wherein the content comprises one or more direct extractions directly extracted from the interaction data, one or more inferences deduced from the interaction data, or combinations thereof;
generating, with the large language model, one or more deduction flag indications, wherein a positive deduction flag indication of the one or more deduction flag indications is generated when the content comprises an inference of the one or more inferences; and
outputting a data set comprising at least one next intent recommendation as a deduction based on the content and the one or more deduction flag indications in the format.

19. The method of claim 18, wherein the interaction data comprises a text file based on the interaction with the user and generated based off an audio file recorded based on the interaction with the user and is processed from audio to text in a JavaScript Object Notation (JSON) format and based on a transcription application program interface (API).

20. The method of claim 19, wherein a negative deduction flag indication of the one or more deduction flag indications is generated when the content comprises a direct extraction of the one or more direct extractions, the positive deduction flag indication corresponds a true value, and the negative deduction flag indication corresponds to a false value.
